(19) United States
(12) Patent Application Publication
(10) Pub. No.: US 2015/0154575 A1
(43) Pub. Date: Jun. 4, 2015

(54) Methods for Storage and Delivery of 3D Printing Digital File

(71) Applicant: Michael F. Krieger, Salt Lake City, UT (US)

(72) Inventor: Michael F. Krieger, Salt Lake City, UT (US)

(21) Appl. No.: 14/547,935

(22) Filed: Nov. 19, 2014

Related U.S. Application Data
(60) Provisional application No. 61/906,215, filed on Nov. 19, 2013.

(51) Int. Cl. G06Q 20/12; B29C 67/00

(52) U.S. Cl. CPC G06Q 20/123; B29C 67/0088; B33Y 50/02

(57) ABSTRACT

Digital files can be gathered, stored and delivered digital files at and through a digital file storage device or computer network for subsequent use in 3D printing. The methods described below are based on the existence of contracts between the owners and/or creators of the 3D printing digital files and the owner/agent of the storage device or computer network designed to gather, store and deliver copies of digital files to individual consumers, in exchange for an agreed upon purchase price

### RELATED APPLICATIONS

This application claims the benefit of U.S. Provisional Patent Application No. 61/906,215 which was filed on Nov. 19, 2013.

### BACKGROUND

3D printing, or additive manufacturing, offers technological advancements to commercial industries which may be unparalleled in its scope and breadth. While 3D printing's genesis occurred nearly thirty years ago, the technology generally remains out of reach for the individual consumer. In post-industrial capital markets, when consumers have needed repairs or replacements of broken or faulty mechanical parts, they have had to procure such parts directly from the original manufacturers, a licensed secondary manufacturer or an after-market manufacturer. This reality creates an inevitable and often costly delay in the return to functionality of a given product. Such delays have far-reaching implications in the growth and development of large national and international corporations as well as the efficient maintenance of personal home and office appliances. Despite the proliferation of 3D printers as response to the decreasing cost of a printer, technological limitations persist.

At present, 3D printers rely on the instructions contained in digital files in order to manufacture products. Every product for which a replacement part may be required must have an individual digital file. Additionally, new products designed to be sold on digital markets with digital blueprints being the only product do not have an effective means of marketing, distribution, or delivery.

### BRIEF SUMMARY

The present invention comprises a digital storefront to which consumers can visit, search a category of products and then download 3d printing instructions to create the product in their home or business. The instructions are cataloged and are available in multiple formats for compatibility with many 3D printers.

### BRIEF DESCRIPTION OF THE SEVERAL VIEWS OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 shows a representative means by which digital files and digital package files are delivered to the digital file repository and subsequently purchase by consumers;

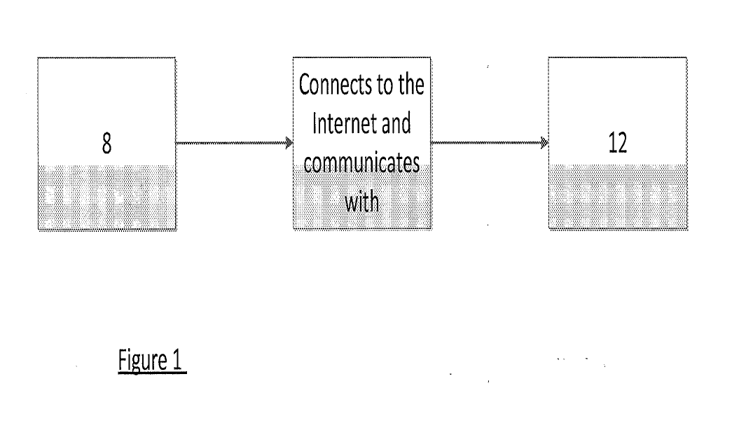

FIG. 2 shows a representative process for creating and storing digital files and digital package files as between the manufacturer, owners, investors, or licensees of products and the owner, licensee or agent of the digital file repository;

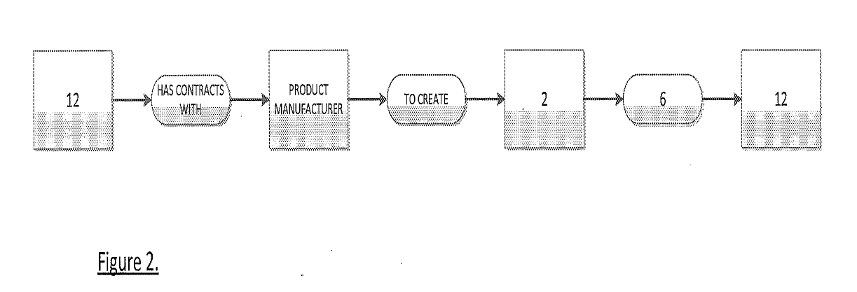

FIG. 3 shows a representative process for how a consumer selects a desired digital file or digital package file and subsequently purchases the desired file or files;

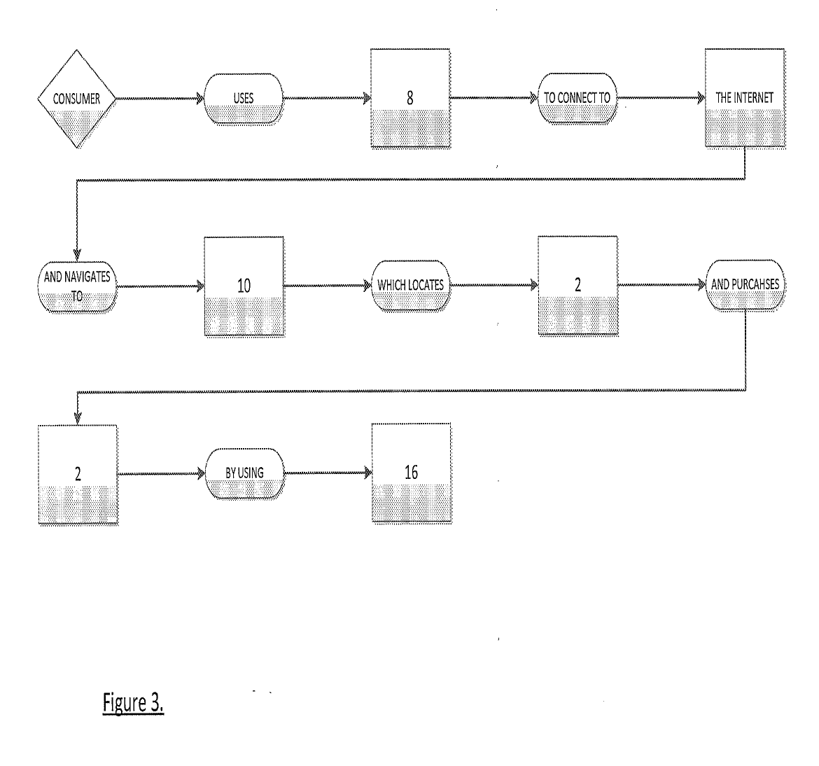

FIG. 4 shows a representative means for delivering the purchased digital file or digital package file to the consumer; and

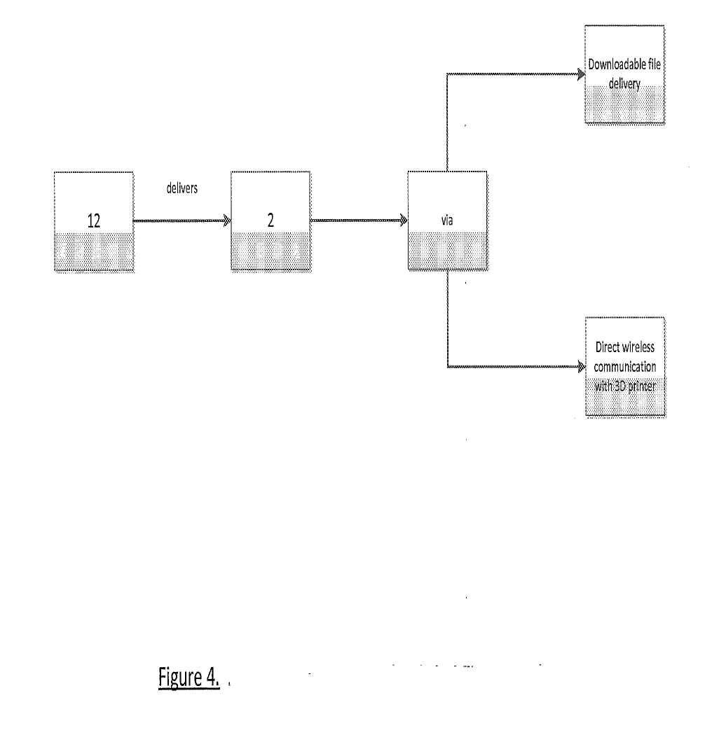

FIG. 5 shows a representative process for dividing the gross income from a purchase according to contractually agreed amount.

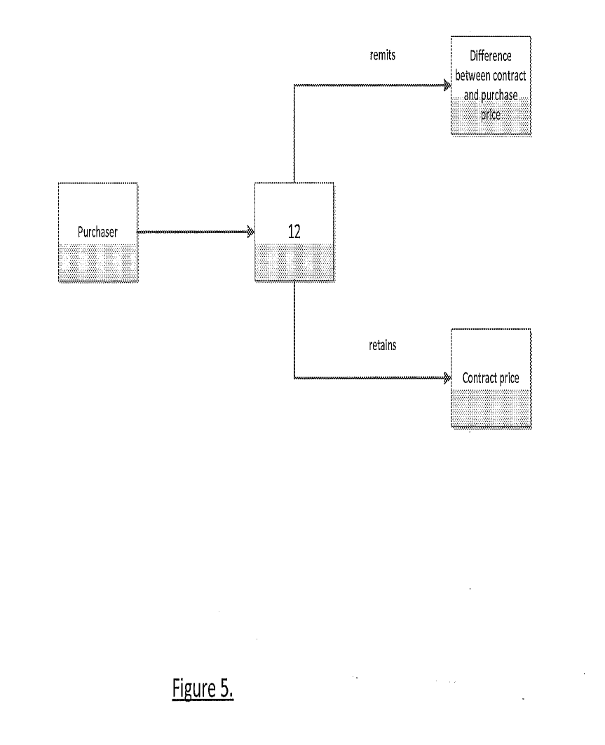

### DETAILED DESCRIPTION OF SOME OF THE PREFERRED EMBODIMENTS

The present invention extends to methods for gathering, storing and delivering digital files at and through a digital file storage device or computer network for subsequent use in 3D printing. The methods described below are based on the existence of contracts between the owners and/or creators of the 3D printing digital files and the owner/agent of the storage device or computer network designed to gather, store and deliver copies of digital files to individual consumers, in exchange for an agreed upon purchase price.

Some embodiments of the present invention may comprise or utilize a general-purpose computer including computer hardware, such as, for example, one or more processors and system memory, as discussed in greater detail below. Some embodiments within the scope of the present invention also include physical and other computer-readable media for carrying or storing computer-executable instructions and/or data structures. Such computer-readable media can be any available media accessible by a general purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium.

Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

In general, a 3D printer-compatible product's owner, either personally or through its licensee or agent, will create a digital file 2. The digital file 2 must be created in a computer-executable digital format 4 capable of being read by publicly available software 6.

The digital file 2 may be created by utilizing a method that is identical to or analogous with a process in which the product's owner, licensee or agent contracts with the owner, licensee or agent of a digital file repository 12 to either (1) remit each unique product SKU to the owner, licensee or agent of the digital file repository 12 or (2) scan each individual part and individual component comprising entire parts, correctly format the digital scan and then electronically deliver the digital file 2 to the owner, licensee or agent of the digital file repository 12 to be catalogued for future retrieval, purchase, and delivery by and to consumers.

Before or after delivering the digital file 2 to the owner, licensee or agent of the digital file repository 12, each product's owner, licensee or agent will identify all related component parts and subparts necessary to replace any complete part capable of 3D printing replacement and refer to the grouping of related digital files 2 as digital package file 3.

After creating the digital file 2, the 3D printer-compatible product's owner, licensee or agent will use a general purpose computer 8 whether in the form of a desktop, laptop, or any mobile computing device, to connect to the internet. The 3D printer-compatible product's owner, licensee or agent will then electronically deliver the digital file 2 and digital package file 3 to the owner, licensee or agent of the digital file repository 12 in which 3D printing files are stored.

A consumer will use the general purpose computer 8, whether in the form of a desktop, laptop, or any mobile computing device, to connect to the internet. A consumer will navigate to a website 10 operated by the owner, licensee or agent of the digital file repository 12. A consumer will select from an available list the digital file 2 or digital package 3 intended for personal purchase. A consumer will purchase the digital file 3 or digital package file 3 through use of an electronic merchant application 16.

The website 10 will send a digital signal to notify the digital file repository 12 that a purchase occurred. The electronic merchant application 16 will utilize the general purpose computer 8 to identify the purchased digital file 2 or digital package file 3. After payment is confirmed, the owner, licensee or agent of the digital file repository 12 will use the computer-executable digital format 4 to electronically deliver the digital file 2 or digital package file 3 to the consumer. The website 10 will then remit to the 3D printer-compatible product's owner, licensee or agent the difference between the purchase price and the contractual portion of the purchase price to which the owner, licensee or agent of the digital file repository 12 is entitled.

Once the consumer receives the digital file 2 or digital package file 3, the general purpose computer 8 will deliver the digital file 2 or digital package file 3 to a connected 3D printer 14. The connected 3D printer 14 will execute the digital file 2 or digital package file 3 and thereby manufacture the desired product purchased by the consumer.

What is claimed is:

1. A method for purchasing a digital file containing compatible and executable instructions for using a 3D printer, comprising:
going to a digital index of digital files for parts or entire devices;
purchasing instructions for a desired part; and
downloading the digital file into a computer in communication with a 3D printer.

2. A method as recited in claim 1, wherein the identification, selection and purchase of a digital file may include related digital files when the files represent each of the several parts of an entire product comprised of multiple distinct component parts.
